(19) United States
(12) Patent Application Publication
(10) Pub. No.: US 2021/0274768 A1
(43) Pub. Date: Sep. 9, 2021

(54) Mosquito killer

(71) Applicant: ZHEJIANG SORBO TECHNOLOGY CO.,LTD., Wenzhou (CN)

(72) Inventors: Yichen Jin, Wenzhou (CN); Lili Liu, Wenzhou (CN); Ke Wang, Wenzhou (CN); Jian Zhang, Wenzhou (CN); Xinxin Zheng, Rui'an (CN)

(21) Appl. No.: 17/211,859

(22) Filed: Mar. 25, 2021

(30) Foreign Application Priority Data
Jul. 29, 2020 (CN) 202021529405.1

(51) Int. Cl. A01M 1/22; A01M 1/04

(52) U.S. Cl. CPC A01M 1/223; A01M 2200/012; A01M 1/04

(57) ABSTRACT

The present invention relates to a mosquito killer, including a mounting base and a mosquito-killing bat unit, wherein the mosquito-killing bat unit, a handle portion and a movably arranged locking piece; and when a mosquito-killing portion of the mosquito-killing bat unit is inserted into an accommodating cavity of the mounting base, the mounting base drives a locking piece to move and unlock the handle portion, and the handle portion may be turned over to one side of the mounting base. By adoption of the above solution, when the mosquito-killing bat unit is arranged on the mounting base or is used singly, the handle portion of the mosquito-killing bat unit may be turned over for storage.

### TECHNICAL FIELD

The utility model relates to a mosquito killer.

### BACKGROUND

There are various mosquitoes in public places or at home, and the mosquitoes will affect the normal rest of people and carry germs, so it is necessary to kill the mosquitoes.

An existing mosquito killer includes a mounting base and a mosquito-killing bat unit, wherein the mosquito-killing bat unit includes a mosquito-killing portion and a handle portion, the mosquito-killing portion is provided with an electric net, the handle portion is provided with a power supply assembly, the mounting base is provided with an accommodating cavity for the mosquito-killing bat unit to insert, and the mounting base is provided with a channel for mosquitoes to enter the accommodating cavity. When the mosquito-killing bat unit is placed at the mounting base, the mosquito-killing portion of the mosquito-killing bat unit and the channel correspondingly form a mosquito-killing area of the mosquito killer. The mosquito-killing bat unit or/and the mounting base is provided with a mosquito-luring lamp, such that the mosquito-killing bat unit may be held to perform mosquito-killing operation, and the mosquito-killing bat unit may be placed on the mounting base to automatically lure and kill the mosquitoes, thereby meeting different mosquito-killing requirements.

However, when the mosquito-killing bat unit is placed on the mounting base, the handle portion of the mosquito-killing bat unit cannot be stored and occupies a large space.

### SUMMARY

The utility model overcomes the defects of the prior art and provides a mosquito killer. When a mosquito-killing bat unit is placed on a mounting base, a handle portion of the mosquito-killing bat unit may be turned over for storage; and when the mosquito-killing bat unit is used singly, the handle portion of the mosquito-killing bat unit can be turned over for storage.

To achieve the above objective, the technical solution adopted by the utility model is: a mosquito killer includes a mounting base and a mosquito-killing bat unit, wherein the mosquito-killing unit includes a mosquito-killing portion and a handle portion, the mosquito-killing portion is provided with an electric net, the handle portion is provided with a power supply assembly, the mounting base is provided with an accommodating cavity for the mosquito-killing bat unit to insert, the accommodating cavity is formed along a length direction of the mounting base, the mounting base is provided with a channel for mosquitoes to enter the accommodating cavity, the mosquito-killing bat unit or/and the mounting base is provided with a mosquito-luring lamp, the handle portion cooperates with the mosquito-killing portion in a hinge manner, the mosquito-killing bat unit is movably provided with a locking piece, the locking piece extends out of the mosquito-killing bat unit, the locking piece may realize locking and unlocking operation on the handle portion, and when the mosquito-killing portion of the mosquito-killing bat unit is inserted into the accommodating cavity, the mounting base drives the locking piece to move and unlock the handle portion and the handle portion may be turned over to one side of the mounting base.

By the above solution, the accommodating cavity is matched with a shape of the mosquito-killing bat unit, and the mosquito-killing bat unit may be directly inserted into the accommodating cavity of the mounting base. Since the mounting base may be placed on the ground and may also be suspended in the air or mounted on the wall, the handle portion of the mosquito-killing bat unit is placed outside the mounting base, such that the mosquito-killing bat unit may be taken and placed by hand conveniently. The mosquito killer may be used to kill mosquitoes and may also kill other different types of insects. The power supply assembly supplies power for the electric net and can control KA of the electric net to turn on and off. When it is necessary to perform handheld mosquito killing, the mosquito-killing bat unit is taken down from the mounting base, and then the mosquito-killing bat unit is turned on. When the mosquitoes are shocked by high voltage of the electric net, mosquito-killing operation may be performed by a handheld method, and at this time, the locking piece locks the handle portion and the handle portion cannot be turned over, thus facilitating operation. When it is unnecessary to kill the mosquitoes, the locking piece may be manually driven to move and unlock the handle portion, and at this time, the handle portion of the mosquito-killing bat unit may be turned over, thus reducing the occupied space of the mosquito-killing bat unit and facilitating storage. When it is necessary to lure and kill the mosquitoes, the mosquito-killing bat unit is mounted on the mounting base, and at this time, the mounting base drives the locking piece to unlock the handle portion, such that the handle portion may be turned over to one side of the mounting base to store the handle portion, thereby reducing the overally occupied space. The mosquito-killing bat unit is turned on, the mosquitoes may fly into the accommodating cavity from the channel of the mounting base and are shocked by high voltage, and at this time, it is only necessary to place the mounting base at a safe position, thus automatically luring and killing the mosquitoes. A mosquito-luring lamp may be singly arranged on the mosquito-killing bat unit or the mounting base, or mosquito-luring lamps may be arranged on the mosquito-killing bat unit and the mounting base. The mosquito-luring lamp can attract and lure the mosquitoes to approach the electric net, thus achieving a more excellent mosquito-killing effect.

The utility model is further set as: the locking piece is slidingly arranged on the mosquito-killing portion or the handle portion, the locking piece is provided with an operation portion and an insertion portion, the operation portion of the locking piece extends out of the mosquito-killing portion or the handle portion, the handle portion or the mosquito-killing portion is provided with an insertion groove for the insertion portion to insert, and the mosquito-killing bat unit is provided with an elastic piece for driving the insertion portion of the locking piece to be inserted into the insertion groove.

By the above solution, the operation portion is pressed to drive the locking piece to slide, the locking piece compresses the elastic piece to make the insertion portion move toward a direction away from the insertion groove, abutting of the operation portion is removed, and the elastic piece may drive the insertion portion to move toward a direction close to the insertion groove. Once the insertion groove is transferred to the insertion portion, the insertion portion is inserted into the insertion groove to lock the handle portion. The structure is simple and operation is convenient.

The utility model is further set as: a hinge base is arranged on an outer side surface of the mosquito-killing portion, an end part of the handle portion is arranged on the hinge base in a hinge manner, the mosquito-killing portion is provided with a sliding cavity for the locking piece to slide at a position close to the hinge base, the operation portion and the insertion portion are located at two ends of the locking piece respectively, the operation portion extends out of the outer side surface of the hinge base, and the insertion portion extends out of an inner side surface of the hinge base.

By the above solution, the hinge base includes a first base body and a second base body which are arranged at intervals, an end part of the handle portion is arranged between the first base body and the second base body in a hinge manner, the first base body and the second base body are arranged hollowly, the operation portion may extend out of one side, away from the second base body, of the first base body, and the insertion portion may extend out of one side, close to the first base body, of the second base body. The structure is simple and the design is reasonable.

The utility model is further set as: the insertion groove is formed in an outer side surface of the handle portion, an outer side surface of the handle portion is provided with a guide inclined surface beside the insertion groove, and the guide inclined surface is arranged along a rotation track of the handle portion.

By the above solution, the insertion groove is formed in a side surface, close to the hinge base, of the handle portion and is arranged along the rotation track of the handle portion. The guide inclined surface is provided, such that the insertion portion is inserted into or separated from the insertion groove conveniently. The structure is simple and the design is reasonable.

The utility model is further set as: the mosquito-killing portion is further provided with a positioning plate for limiting the locking piece from being separated from the sliding cavity, the positioning plate is fixedly connected to the hinge base, the positioning plate is provided with a through hole for the insertion portion to extend out, the positioning plate is in a guide sliding fit with the locking piece, the positioning plate is provided with an abutting portion, the elastic piece is a spring, and one end of the spring abuts against the locking piece and the other end of the spring abuts against the abutting portion.

By the above solution, the positioning plate may limit the locking piece from being separated from the sliding cavity, the positioning plate is provided with a guide block, the locking piece is provided with a guide groove, the guide block cooperates with the guide groove to realize a guide sliding fit of the positioning plate and the locking piece, the insertion portion may extend out of the through hole of the positioning plate and is inserted into the insertion groove of the handle portion, and the spring is mounted stably.

The utility model is further set as: the mounting base is provided with an opening for the insertion portion to insert, and a side wall of the opening may abut against the operation portion of the locking piece, such that the insertion portion of the locking piece is separated from the insertion groove.

By the above solution, since the hinge base is arranged convexly and the arrangement of the opening may avoid interference with the hinge base, when the mosquito-killing bat unit is placed on the mounting base, a side wall at the opening may abut against the operation portion of the locking piece, such that the insertion portion of the locking piece is separated from the insertion groove, the handle portion may be turned over for storage, it is unnecessary to manually drive the locking piece to move for unlocking, the structure is simple and the design is reasonable.

The utility model is further set as: the mounting base is provided with a placing cavity matched with a shape of the handle portion on one side of the opening, the handle may be placed in the placing cavity after being turned over, and a clamping block for limiting the handle portion from being separated from the placing cavity is arranged on a side wall of the placing cavity.

By the above solution, when the mosquito-killing bat unit is placed at the mounting base, the handle portion is just placed in the placing cavity after being turned over, such that the overall structure is more compact; moreover, the clamping block may clamp the handle portion and does not apply an overturning force to the handle portion, the handle portion is not separated from the placing cavity, the structure is simple, and mounting stability is achieved.

The utility model is further set as: the mosquito-killing portion is provided with a mosquito-killing fixed ring, the electric net is mounted on the mosquito-killing fixed ring, the mosquito-luring lamp is arranged beside the mosquito-killing fixed ring, a light guide plate for light of the mosquito-luring lamp to guide out is arranged on the mosquito-killing fixed ring, there are two light guide plates, the electric net is clamped between the two light guide plates, and the mosquito-killing portion is provided with protective nets respectively on two sides of the light guide plates.

By the above solution, the electric net is mounted on the mosquito-killing fixed ring, and the light guide plate approaches the electric net, such that the mosquito-luring effect is more excellent. The mosquito-luring lamp may emit lamplight after being electrified, and the light guide plate is used to conduct lamplight, such that the diverging range of the lamplight is increased, the setting number of the mosquito-luring lamps may be reduced and more energy is saved. The electric net is clamped between two light guide blocks, such that the electric net is mounted more stably. There are two protective nets which are mounted on the mosquito-killing fixed ring, such that electric shock may be prevented. Moreover, holes in the protective nets may allow the mosquitoes to fly in.

The utility model is further set as: the mosquito-killing portion is provided with a first conductive contact, the mounting base is provided with a charging circuit board at a port of the accommodating cavity, the charging circuit board is provided with a second conductive contact, and when the mosquito-killing portion of the mosquito-killing bat unit is inserted into the accommodating cavity, the first conductive contact is in contact with the second conductive contact.

By the above solution, when the mosquito-killing bat unit is placed at the mounting base, the charging circuit board may be externally connected to a power supply; moreover, the first conductive contact is in contact with the second conductive contact and may perform charging operation on the mosquito-killing bat unit, such that the structure is simple and the design is reasonable.

The utility model is further set as: one side of the mounting base in a width direction extends to form a supporting wall.

By the above solution, when the mounting base is placed, one side of the supporting wall faces downward. The arrangement of the supporting wall may increase the contact area with the ground, such that the mounting base is placed more stably.

The utility model is further described with reference to the accompanying drawings.

### BRIEF DESCRIPTION OF THE DRAWINGS

FIG. 1 is a schematic diagram of an exploded structure of a mosquito-killing bat unit and a mounting base;

FIG. 2 is a structural schematic diagram of a mosquito-killing bat unit inserted into a mounting base;

FIG. 3 is a schematic diagram of a storage state of a mosquito-killing bat unit;

FIG. 4 is a structural schematic diagram of a mosquito-killing portion of a mosquito-killing bat unit;

FIG. 5 is a schematic diagram of a mounting structure of a locking piece;

FIG. 6 is a structural schematic diagram of a locking piece;

FIG. 7 is a structural schematic diagram of a handle portion of a mosquito-killing bat unit;

FIG. 8 is a schematic diagram of an enlarged structure of FIG. 7;

FIG. 9 is a schematic diagram of an internal structure of a mosquito-killing portion;

FIG. 10 is a structural schematic diagram of a mounting base;

FIG. 11 is a structural schematic diagram of a bottom surface of the positioning plate;

FIG. 12 is a structural schematic diagram of a front surface of a positioning plate; and

FIG. 13 is a schematic diagram of an cooperation structure of a first conductive contact and a second conductive contact.

### DETAILED DESCRIPTION OF THE EMBODIMENTS

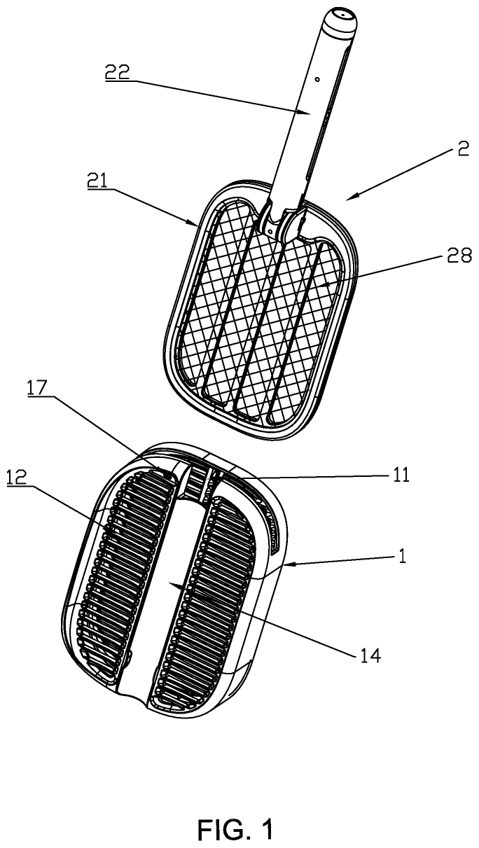

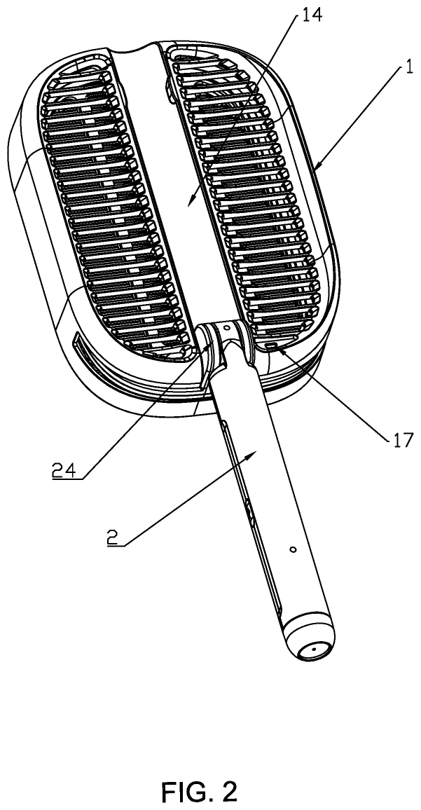

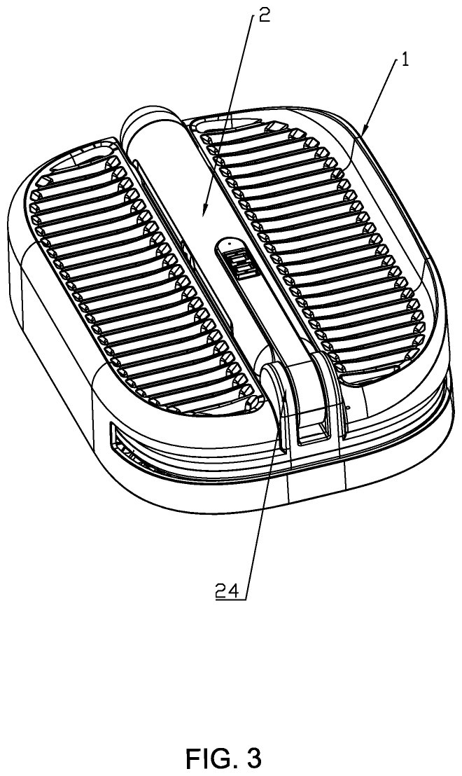

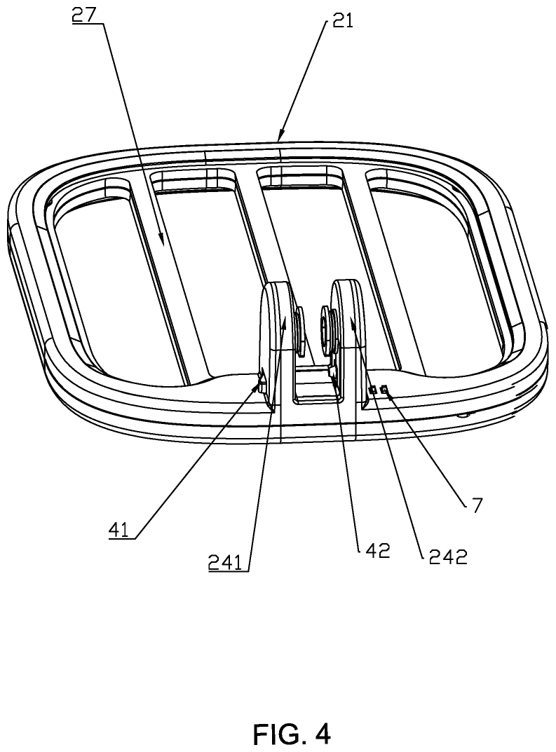

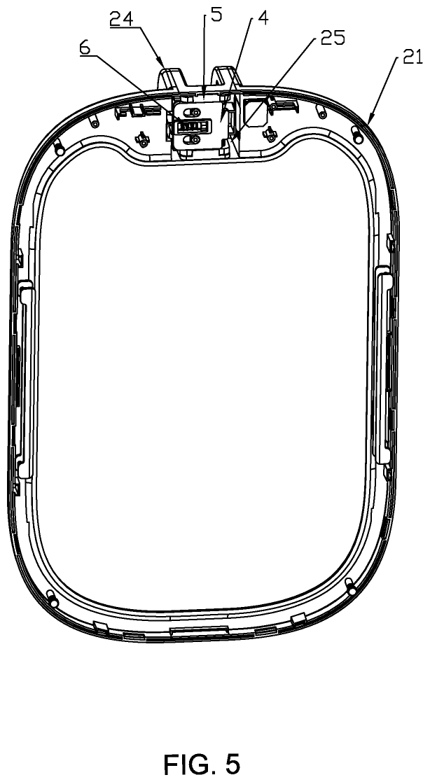

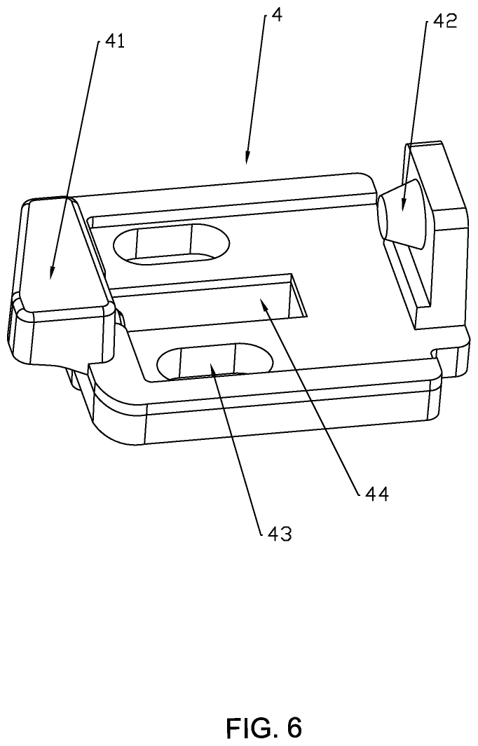

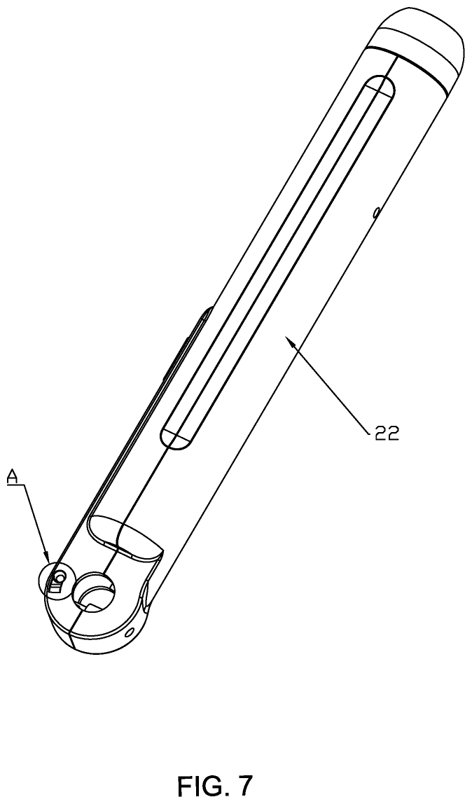

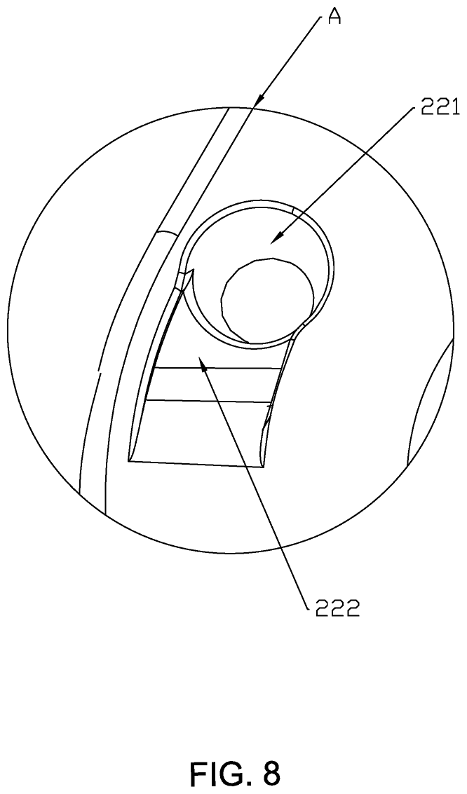

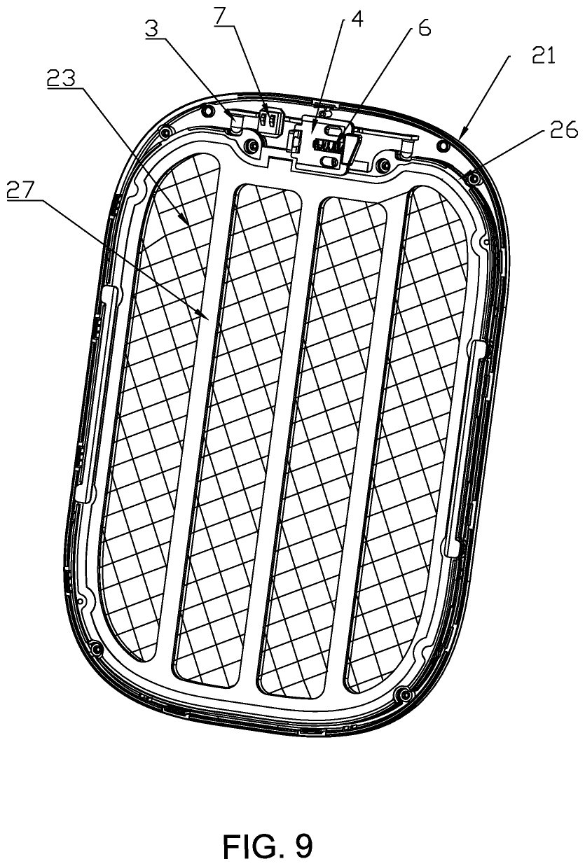

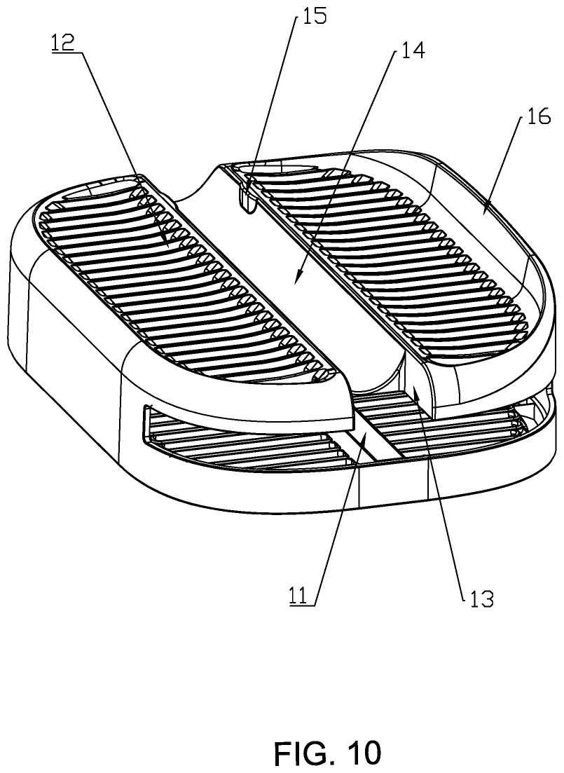

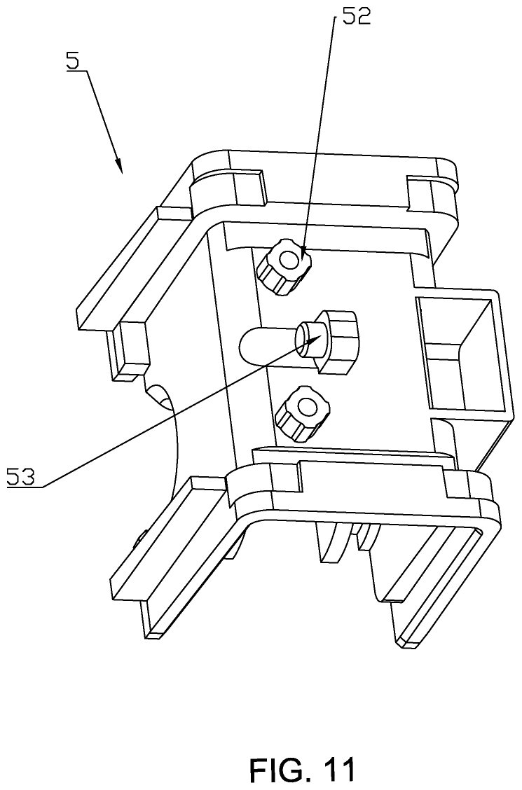

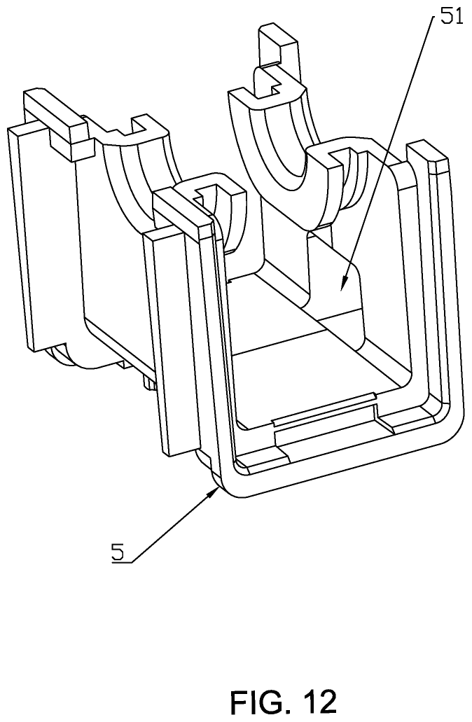

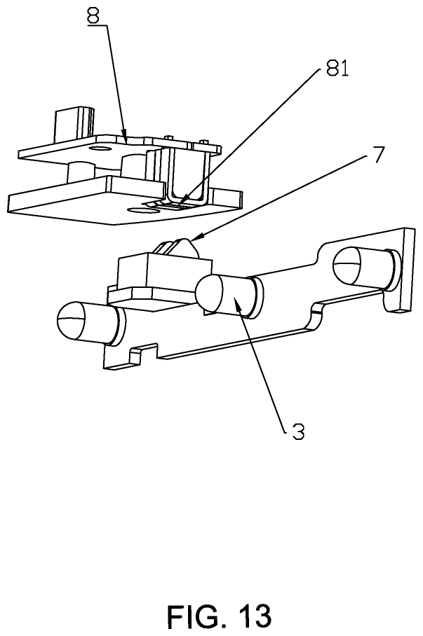

As shown in FIG. 1 to FIG. 13, A mosquito killer includes a mounting base 1 and a mosquito-killing bat unit 2, wherein the mosquito-killing unit 2 includes a mosquito-killing portion 21 and a handle portion 22, the mosquito-killing portion 21 is provided with an electric net 23, the handle portion 22 is provided with a power supply assembly, the mounting base 1 is provided with an accommodating cavity 11 for the mosquito-killing bat unit 2 to insert, the accommodating cavity 11 is formed along a length direction of the mounting base 1, the mounting base 1 is provided with a channel 12 for mosquitoes to enter the accommodating cavity 11, the mosquito-killing bat unit 2 or/and the mounting base 1 is provided with a mosquito-luring lamp 3, the handle portion 22 cooperates with the mosquito-killing portion 21 in a hinge manner, the mosquito-killing bat unit 2 is movably provided with a locking piece 4, the locking piece 4 extends out of the mosquito-killing bat unit 2, the locking piece 4 may realize locking and unlocking operation on the handle portion 22, and when the mosquito-killing portion 21 of the mosquito-killing bat unit 2 is inserted into the accommodating cavity 11, the mounting base 1 drives the locking piece 4 to move and unlock the handle portion 22 and the handle portion 22 may be turned over to one side of the mounting base 1.

In this embodiment, the locking piece 4 is slidingly arranged on the mosquito-killing portion 21, the locking piece 4 is provided with an operation portion 41 and an insertion portion 42, the operation portion 41 of the locking piece 4 extends out of the mosquito-killing portion 21, the handle portion 22 is provided with an insertion groove 221 for the insertion portion 42 to insert, and the mosquito-killing portion 21 is provided with an elastic piece for driving the insertion portion 42 of the locking piece 4 to be inserted into the insertion groove 221. Of course, the locking piece 4 may be sliding arranged on the handle portion 22. Of course, the locking piece 4 may adopt a swing manner, which is not limited a sliding manner.

In this embodiment, a hinge base 24 is arranged on an outer side surface of the mosquito-killing portion 21, the hinge base 24 includes a first base body 241 and a second base body 242 which are arranged at intervals, an end part of the handle portion 22 is arranged between the first base body 241 and the second base body 242 in a hinge manner, the first base body 241 and the second base body 242 are arranged hollowly, the mosquito-killing portion 21 is provided with a sliding cavity 25 for the locking piece 4 to slide at a position close to the hinge base 24, the operation portion 41 and the insertion portion 42 are located at two ends of the locking piece 4 respectively, the operation portion 41 may extend out of one side, away from the second base body 242, of the first base body 241, and the insertion portion 42 may extend out of one side, close to the first base body 241, of the second base body 242.

In this embodiment, the insertion groove 221 is formed in an outer side surface of one side, close to the second base body 242, of the handle portion 22, the outer side surface of the handle portion 22 is further provided with a guide inclined surface 222 beside the insertion groove 221, and the guide inclined surface 222 is arranged along the rotation track of the handle portion 22.

In this embodiment, the mosquito-killing portion 21 is further provided with a positioning plate 5 for limiting the locking piece 4 from being separated from the sliding cavity 25, the positioning plate 5 and the hinge base 24 are fixedly connected, the positioning plate 5 is provided with a through hole 51 for the insertion portion 42 to extend out, the positioning plate 5 is provided with a guide block 52, the locking piece 4 is provided with a guide groove 43, the guide block 52 cooperates with the guide groove 43 to realize a guide sliding fit of the positioning plate 5 and the locking piece 4, the positioning plate is provided with an abutting portion 53, the elastic piece is a spring 6, the locking piece 4 is provided with an accommodating cavity 44 for the spring 6 to place, the abutting portion 53 is inserted into the accommodating cavity 44, and one end of the spring 6 abuts against an end face of the accommodating cavity 44 and the other end of the spring 6 abuts against the abutting portion 53. Of course, the elastic piece may be a tension spring or a torsional spring.

In this embodiment, the mounting base 1 is provided with an opening 13 for the hinge base 24 to insert, and a side wall of the opening 13 may abut against the operation portion 41 of the locking piece 4, such that the insertion portion 42 of the locking piece 4 is separated from the insertion groove 221.

In this embodiment, the mounting base 1 is provided with a placing cavity 14 matched with a shape of the handle portion 22 on one side of the opening 13, the handle portion 22 may be placed in the placing cavity 14 after being turned over, and a clamping block 15 for limiting the handle portion 22 from being separated from the placing cavity 14 is arranged on a side wall of the placing cavity 14.

In this embodiment, the mosquito-killing portion 21 is provided with a mosquito-killing fixed ring 26, an electric net 23 is mounted on the mosquito-killing fixed ring 26, a mosquito-luring lamp 3 is arranged beside the mosquito-killing fixed ring 26, the mosquito-killing fixed ring 26 is further provided with two light guide plates 27 for light of the mosquito-luring lamp 3 to guide out, the electric net 23 is clamped between the two light guide plates 27, and the mosquito-killing portion 21 is provided with protective nets 28 respectively on two sides of the light guide plates 27.

In this embodiment, the mosquito-killing portion 21 is provided with a first conductive contact 7, the mounting base 1 is provided with a charging circuit board 8 at a port of the accommodating cavity 11, and the charging circuit board 8 is provided with a second conductive contact 81. When the mosquito-killing portion 21 of the mosquito-killing bat unit 2 is inserted into the accommodating cavity 11, the first conductive contact 7 is in contact with the second conductive contact 81, and the mounting base 1 is further provided with a charging port 17.

In this embodiment, one side of the mounting base 1 in a width direction extends to form a supporting wall 16.

The above embodiments are only preferred specific embodiments of the utility model, and usual changes and substitutions made by those skilled in the art within the scope of the technical solution of the utility model should be included in the protection scope of the utility model.

What is claimed is:

1. A mosquito killer, comprising a mounting base and a mosquito-killing bat unit, wherein the mosquito-killing unit comprises a mosquito-killing portion and a handle portion, the mosquito-killing portion is provided with an electric net, the handle portion is provided with a power supply assembly, the mounting base is provided with an accommodating cavity for the mosquito-killing bat unit to insert, the accommodating cavity is formed along a length direction of the mounting base, the mounting base is provided with a channel for mosquitoes to enter the accommodating cavity, the mosquito-killing bat unit or/and the mounting base is provided with a mosquito-luring lamp, the handle portion cooperates with the mosquito-killing portion in a hinge manner, the mosquito-killing bat unit is movably provided with a locking piece, the locking piece extends out of the mosquito-killing bat unit, the locking piece may realize locking and unlocking operation on the handle portion, and when the mosquito-killing portion of the mosquito-killing bat unit is inserted into the accommodating cavity, the mounting base drives the locking piece to move and unlock the handle portion and the handle portion may be turned over to one side of the mounting base.

2. The mosquito killer according to claim 1, wherein the locking piece is slidingly arranged on the mosquito-killing portion or the handle portion, the locking piece is provided with an operation portion and an insertion portion, the operation portion of the locking piece extends out of the mosquito-killing portion or the handle portion, the handle portion or the mosquito-killing portion is provided with an insertion groove for the insertion portion to insert, and the mosquito-killing bat unit is provided with an elastic piece for driving the insertion portion of the locking piece to be inserted into the insertion groove.

3. The mosquito killer according to claim 2, wherein a hinge base is arranged on an outer side surface of the mosquito-killing portion, an end part of the handle portion is arranged on the hinge base in a hinge manner, the mosquito-killing portion is provided with a sliding cavity for the locking piece to slide at a position close to the hinge base, the operation portion and the insertion portion are located at two ends of the locking piece respectively, the operation portion extends out of the outer side surface of the hinge base, and the insertion portion extends out of an inner side surface of the hinge base.

4. The mosquito killer according to claim 2, wherein the insertion groove is formed in an outer side surface of the handle portion, an outer side surface of the handle portion is provided with a guide inclined surface beside the insertion groove, and the guide inclined surface is arranged along a rotation track of the handle portion.

5. The mosquito killer according to claim 3, wherein the insertion groove is formed in an outer side surface of the handle portion, an outer side surface of the handle portion is provided with a guide inclined surface beside the insertion groove, and the guide inclined surface is arranged along a rotation track of the handle portion.

6. The mosquito killer according to claim 3, wherein the mosquito-killing portion is further provided with a positioning plate for limiting the locking piece from being separated from the sliding cavity, the positioning plate is fixedly connected to the hinge base, the positioning plate is provided with a through hole for the insertion portion to extend out, the positioning plate is in a guide sliding fit with the locking piece, the positioning plate is provided with an abutting portion, the elastic piece is a spring, and one end of the spring abuts against the locking piece and the other end of the spring abuts against the abutting portion.

7. The mosquito killer according to claim 2, wherein the mounting base is provided with an opening for the insertion portion to insert, and a side wall of the opening may abut against the operation portion of the locking piece, such that the insertion portion of the locking piece is separated from the insertion groove.

8. The mosquito killer according to claim 3, wherein the mounting base is provided with an opening for the insertion portion to insert, and a side wall of the opening may abut against the operation portion of the locking piece, such that the insertion portion of the locking piece is separated from the insertion groove.

9. The mosquito killer according to claim 7, wherein the mounting base is provided with a placing cavity matched with a shape of the handle portion on one side of the opening, the handle may be placed in the placing cavity after being turned over, and a clamping block for limiting the handle portion from being separated from the placing cavity is arranged on a side wall of the placing cavity.

10. The mosquito killer according to claim 8, wherein the mounting base is provided with a placing cavity matched with a shape of the handle portion on one side of the opening, the handle may be placed in the placing cavity after being turned over, and a clamping block for limiting the handle portion from being separated from the placing cavity is arranged on a side wall of the placing cavity.

11. The mosquito killer according to claim 1, wherein the mosquito-killing portion is provided with a mosquito-killing fixed ring, the electric net is mounted on the mosquito-killing fixed ring, the mosquito-luring lamp is arranged beside the mosquito-killing fixed ring, a light guide plate for light of the mosquito-luring lamp to guide out is arranged on the mosquito-killing fixed ring, there are two light guide plates, the electric net is clamped between the two light guide plates, and the mosquito-killing portion is provided with protective nets respectively on two sides of the light guide plates.

12. The mosquito killer according to claim 2, wherein the mosquito-killing portion is provided with a mosquito-killing fixed ring, the electric net is mounted on the mosquito-killing fixed ring, the mosquito-luring lamp is arranged beside the mosquito-killing fixed ring, a light guide plate for light of the mosquito-luring lamp to guide out is arranged on the mosquito-killing fixed ring, there are two light guide plates, the electric net is clamped between the two light guide plates, and the mosquito-killing portion is provided with protective nets respectively on two sides of the light guide plates.

13. The mosquito killer according to claim 3, wherein the mosquito-killing portion is provided with a mosquito-killing fixed ring, the electric net is mounted on the mosquito-killing fixed ring, the mosquito-luring lamp is arranged beside the mosquito-killing fixed ring, a light guide plate for light of the mosquito-luring lamp to guide out is arranged on the mosquito-killing fixed ring, there are two light guide plates, the electric net is clamped between the two light guide plates, and the mosquito-killing portion is provided with protective nets respectively on two sides of the light guide plates.

14. The mosquito killer according to claim 1, wherein the mosquito-killing portion is provided with a first conductive contact, the mounting base is provided with a charging circuit board at a port of the accommodating cavity, the charging circuit board is provided with a second conductive contact, and when the mosquito-killing portion of the mosquito-killing bat unit is inserted into the accommodating cavity, the first conductive contact is in contact with the second conductive contact.

15. The mosquito killer according to claim 2, wherein the mosquito-killing portion is provided with a first conductive contact, the mounting base is provided with a charging circuit board at a port of the accommodating cavity, the charging circuit board is provided with a second conductive contact, and when the mosquito-killing portion of the mosquito-killing bat unit is inserted into the accommodating cavity, the first conductive contact is in contact with the second conductive contact.

16. The mosquito killer according to claim 3, wherein the mosquito-killing portion is provided with a first conductive contact, the mounting base is provided with a charging circuit board at a port of the accommodating cavity, the charging circuit board is provided with a second conductive contact, and when the mosquito-killing portion of the mosquito-killing bat unit is inserted into the accommodating cavity, the first conductive contact is in contact with the second conductive contact.

17. The mosquito killer according to claim 1, wherein one side of the mounting base in a width direction extends to form a supporting wall.

18. The mosquito killer according to claim 2, wherein one side of the mounting base in a width direction extends to form a supporting wall.

19. The mosquito killer according to claim 3, wherein one side of the mounting base in a width direction extends to form a supporting wall.
